(19) United States
(12) Patent Application Publication
(10) Pub. No.: US 2024/0426424 A1
(43) Pub. Date: Dec. 26, 2024

(54) DEVICE FOR PROCESSING PRODUCTS

(71) Applicant: Nordischer Maschinenbau Rud. Baader GmbH + Co. KG, Lübeck (DE)

(72) Inventors: Roman Ludwig Gottschalk, Lübeck (DE); André Von Selle, Lübeck (DE)

(21) Appl. No.: 18/695,621

(22) PCT Filed: Aug. 10, 2022
(86) PCT No.: PCT/EP2022/072446

§ 371 Date: Mar. 26, 2024

(30) Foreign Application Priority Data
Oct. 1, 2021 (EP) 21200424.6

(51) Int. Cl. F16P 3/08; F16P 3/00

(52) U.S. Cl. CPC F16P 3/08; F16P 3/008

(57) ABSTRACT

An apparatus configured and adapted for working and/or processing products includes a housing having a work area for accommodating at least one working station, at least one working station within the work area, and a movable cover for opening and closing the housing and covering the work area with respect to the surroundings. The or each working station has at least one pneumatically actuatable tool, the tool and the movable cover being operatively connected by a safety device in such a way that opening of the cover inevitably leads to the tool being stopped. The safety device has a safety valve that is configured to be switchable solely in a mechanical manner and, for that purpose, is operatively connected to the cover at least in a form-fitting and/or frictional manner.

### CROSS-REFERENCE TO RELATED APPLICATIONS

This application is the U.S. National Stage of PCT/EP2022/072446 filed on Aug. 10, 2022, which claims priority to European Patent Application 21200424.6 filed on Oct. 1, 2021, the entire content of both are incorporated herein by reference in their entirety.

### FIELD OF THE INVENTION

The invention relates to an apparatus configured and adapted for working and/or processing products, comprising a housing having a work area for accommodating at least one working station, at least one working station within the work area, a movable cover for opening and closing the housing and covering the work area with respect to the surroundings, the or each working station comprising at least one pneumatically actuatable tool, and the tool and the movable cover being operatively connected by means of a safety device in such a way that the opening of the cover inevitably leads to the tool being stopped.

### BACKGROUND OF THE INVENTION

Such apparatuses are used in many different sectors in order to protect operators from reaching into tools that are currently in operation. For working and/or processing purposes, the products are either inserted into the working station with the cover open, or the products are transported, by means of a transportation device, to and through the working station arranged inside the housing. While the working station is in operation, the housing is closed. For this purpose, the cover is in a closed position. The cover, which may also be any other flap, door or safety apparatus, blocks the working station off from the surroundings to prevent any access while the apparatus is in operation. The closed cover spatially separates the operator from the work area. However, for the purposes of maintaining, cleaning and inspecting the products and/or the working station, for example, the operator needs to access the work area. To do so, the cover has to be folded, slid, pivoted or otherwise opened into an open access position. Yet to avoid injuries, access should only be possible when the or each working station has stopped.

For this purpose, the apparatuses are secured in such a way that the or each working station is stopped as soon as the tools are freely accessible, i.e. when the cover is open. A classic case occurs when an operator opens the cover in order to obtain access to the interior of the apparatus, i.e. to the accommodating area or work area, for example to be able to undertake maintenance work or remove products or parts thereof from the apparatus. Accordingly, solutions are known in which the or each tool covered by the cover is shut down as soon as the cover is opened. For this purpose, a safety device is provided. The or each pneumatically driven tool is operatively connected to the cover by means of the safety device. If said cover is opened, the safety device ensures that the compressed air applied to the tools can escape quickly so as to render the tools inoperative.

In known solutions, in particular from the food processing industry, for example poultry or in particular fish processing, there is a known safety device for this purpose, which comprises a solenoid and electrically actuated solenoid valves that are actively controlled by means of a controller. The solenoid is triggered when the cover, which incidentally can also be any cupboard door, inspection flap or the like, is opened, as a result of which a signal is transmitted to the controller. In turn, the controller actuates the solenoid valves, which open or close depending on the situation and thus allow the compressed air to escape from the tools. In other words, the solenoid valves are actuated by means of complex interconnections so that, for example, when the cover is opened, the feed of compressed air in particular to the or each tool is interrupted and, at the same time, the release of the compressed air applied to the tools is activated. The above-described solution has a multiplicity of components and requires a complex interconnection. Moreover, the service life of said components, in particular of the solenoid valves, is limited since they cannot durably withstand the prevailing conditions in the food industry. In the fish processing industry in particular, the water creates an environment that is liable to cause malfunctions, in particular for the solenoid valves and other switch elements and component parts. Since the failure of a safety-relevant component results in the entire apparatus being shut down, and since troubleshooting is complex, the known solution is considered disadvantageous. Furthermore, design-related tolerances, for example clearances and production tolerances in the region of the solenoid, lead to the apparatus cutting out again and again in an undesirable manner.

Therefore, the problem addressed by the invention is to propose a simple and robust apparatus that guarantees a reliable and long-lasting safety cut-out, in particular even in difficult environmental conditions.

### SUMMARY OF THE INVENTION

This problem is solved by an apparatus of the type mentioned at the outset in that the safety device comprises a safety valve that is configured to be switchable solely in a mechanical manner and, for that purpose, is operatively connected to the cover at least in a form-fitting and/or frictional manner. The operative connection between the cover and the safety valve can also be established in a different way, for example by an integral bond or by the combination of an integral bond and/or a form fit and/or a frictional fit. A simple and robust configuration of the safety device, foregoing any electrical and/or electronic component parts and lines in order to reduce the number of different parts on the one hand and also the susceptibility of the safety device to malfunctions on the other hand, is essential for the invention. Since the ventilation and evacuation of the apparatus, i.e. in particular also the switching of the safety valve when the cover is actuated, is carried out using a purely mechanical safety valve, the apparatus has a simple and robust construction and is particularly applicable for use in the food processing industry. These advantages are boosted by the reduction in the number of different parts and by the foregoing of electrical/electronic components. Another advantage is that the simple construction considerably simplifies, and thus shortens, the maintenance of the apparatus, which can also be carried out by operators who have undergone less intensive training.

An advantageous development of the invention is characterised in that the safety valve is configured as a 3/2 valve, the safety valve comprising an air inlet for feeding compressed air into the safety valve, an air outlet for releasing compressed air from the safety valve and a supply inlet for supplying compressed air to the or each tool. By providing three compressed-air openings, namely the air inlet, air outlet and supply inlet on the one hand, and by supplying two flow connections, namely between the air inlet and the supply inlet and between the supply inlet and the air outlet, on the other hand, a compact and robust safety device is created, which operates reliably and durably in particular even under extreme environmental conditions. The flow connections either constitute air chambers or are provided by air chambers, in which the compressed air can flow in both directions depending on the switching state of the safety valve and in which pressure can build or drop.

Particularly preferably, the safety valve comprises a hollow cylinder having a cavity in which a push rod is guided in a sliding manner, the hollow cylinder being configured in a closed manner at one end face and in an open manner at the opposite end face in such a way that the push rod protrudes out of the hollow cylinder at the open end face. Such hollow cylinders, which are preferably cylindrical in shape, have an inner wall that is formed at a distance from the push rod at least in some portions over the length of the hollow cylinder in order thus to create air chambers for forming the flow connections between the compressed-air openings. This configuration allows the safety valve to be switched in a purely mechanical way in a particularly simple manner.

Advantageously, the push rod is inherently arranged with its outside circumference at a distance from an inner wall of the hollow cylinder in order to form air chambers, the push rod comprising at least three sealing members by which the push rod abuts the inner wall of the hollow cylinder in a sealing manner. Accordingly, the push rod has different cross sections in its longitudinal extent. In regions where the cross section is larger, i.e. projections/raised portions or the like on the push rod, simple O-rings are arranged, for example, in order to be able to divide the cavity of the hollow cylinder into a plurality of air chambers or portions of the air chamber that ensure the flow connections between the individual compressed-air openings. However, other sealing members can also be used instead of the O-rings. The number of sealing members and their configuration and/or position can also vary.

Expediently, the air inlet, the air outlet and the supply inlet open into the cavity of the hollow cylinder, the establishment of flow connections between the air inlet and/or air outlet and/or supply inlet being able to be varied by means of the movable push rod. This ensures simple, purely mechanical switching of the safety device. The different flow connections can be switched merely by the mechanical displacement of the push rod inside the hollow cylinder.

Advantageously, the cover is assigned an actuation lever, which comprises a cam disc that is operatively connected to the push rod assigned to the safety valve. The cam disc can also be assigned directly to the cover. Preferably, the cam disc is rotatable together with the actuation lever about an axis of rotation D. Owing to the curved path of the cam disc, the position of the push rod inside the hollow cylinder changes as a result of the operative connection to the push rod. Therefore, the push rod can be switched back and forth by means of the cam disc in order to switch the respective flow connections.

Expediently, the push rod is configured and adapted to be movable, by means of the cam disc, out of a work position, in which the cover is closed and the push rod on the one hand ensures a flow connection between the air inlet and the supply inlet and on the other hand blocks the air outlet, into a stop position, in which the cover is opened and the push rod on the one hand ensures a flow connection between the supply inlet and the air outlet and on the other hand blocks the air inlet, and back again. The curved path of the cam disc is configured accordingly to guarantee the two extreme positions of the push rod, namely the work position on the one hand and the stop position on the other hand. In the work position, the push rod activates those air chambers or portions of the air chamber that form the first air path between the air inlet and the supply inlet whereas the air outlet is blocked. Thus, compressed air is applied to the tools so that they are operational and ready for use. Loss of compressed air via the air outlet is prevented. In the stop position, the push rod activates those air chambers or portions of the air chamber that form the second air path between the supply inlet and the air outlet whereas the air inlet is blocked. As a result, compressed air is no longer applied in the tools. On the contrary, the compressed air can escape from the tools via the air outlet such that the tools are unpressurised and therefore stopped. Thus, the risk of injury is safely and reliably ruled out when the cover is open. The apparatus according to the invention is constructed so simply and robustly that undesirable cut-outs are effectively prevented.

A particularly preferred development is characterised in that the cam disc, as a closed cam disc, is configured and adapted for producing a constant form fit and/or frictional fit with the push rod in order to switch the safety valve. A slot-like, closed curved path is formed in the cam disc and ensures that the push rod is permanently guided in a positive manner. For this purpose, a connecting bolt is preferably arranged at a free end of the push rod, said free end protruding out of the hollow cylinder, and is guided in the closed curved path of the cam disc. The connecting bolt can be directly, and preferably releasably, fastened to the push rod or to its free end. Preferably, the free end of the push rod is arranged on a connecting member, to which the connecting bolt is in turn preferably releasably fastened. Rotating the cam disc about the axis of rotation D causes the push rod to perform, in a manner triggered purely mechanically, a linear movement into the hollow cylinder (towards the stop position when the cover is open) and out of the hollow cylinder (towards the work position when the cover is closed).

Advantageously, the air inlet and the air outlet are arranged one behind the other in the longitudinal direction of the hollow cylinder, the air outlet being arranged closer to the open end face of the hollow cylinder. This arrangement allows each flow connection to be activated by simple linear movements. Since the air inlet is arranged towards the closed end face of the hollow cylinder, the stop position of the push rod can be reached purely mechanically in a particularly simple manner.

Expediently, the air inlet and the air outlet are arranged at a distance from one another in the longitudinal direction of the hollow cylinder, the distance being large enough so that the supply inlet is arranged and configured between the air inlet and the air outlet. Thus, extremely short switching paths between the individual flow connections are implemented, such as to guarantee that the push rod is switched into the two positions, namely the work position and the stop position, precisely and reliably.

A preferred embodiment is characterised in that the air inlet and the air outlet on the one hand and the supply inlet on the other hand are arranged on opposite sides of the hollow cylinder when viewed radially. Owing to this arrangement, with the air inlet and the air outlet on one side and the supply inlet on the opposite side, the aforementioned advantages are boosted further, and specifically in a very compact design.

A particularly advantageous development is characterised in that a spring element is assigned to the safety valve, the spring element being adapted and arranged such that, using a spring force, it pushes the push rod inwards into the hollow cylinder in the direction of the stop position. The arrangement and orientation of the spring element accordingly ensures that a constant pressure on the push rod urges it towards the stop position. Therefore, if, for example, the connection between the push rod and the cam disc is broken or severed, the spring element ensures that the push rod is immediately moved into its stop position. This creates a second safety level of rendering the tools inoperative when the cover is opened and the first safety level, by way of the operative connection between the cover or cam disc and the push rod, is inoperative.

Advantageously, a compression spring is arranged in the region of the open end face of the hollow cylinder and abuts a projection on the push rod in such a way that a constant spring pressure is applied to the push rod in the direction of the closed end face of the hollow cylinder. Thus, the spring element presses the push rod against the hollow cylinder, as a counter-bearing, into the stop position in the event that the operative connection between the cam disc and the push rod is broken. This achieves a compact and reliable second safety level.

A further advantageous embodiment is characterised in that, in the work position within an air chamber in the flow connection between the air inlet and the supply inlet, an air pressure is applied that subjects the push rod to a pressure force that is directed inwards into the hollow cylinder in the direction of the stop position. Put a simpler way, the pressure from the tools or the pressure applied to the tools works counter to the work position. In other words, the selected pressure conditions within the air chambers ensure that, in the event that both the first safety level, namely the operative connection between the cam disc and the push rod, and the second safety level, namely the spring element, fail, the push rod is moved into its stop position solely by the air pressure in the air chamber for forming the air flow duct between the air inlet and the supply inlet. This creates a third safety level of rendering the tools inoperative when the cover is opened and the first safety level, by way of the operative connection between the cover or cam disc and the push rod, is inoperative and the second safety level using the spring element has also failed.

### BRIEF DESCRIPTION OF THE DRAWINGS

Other expedient and/or advantageous features and developments in relation to the apparatus emerge from the dependent claims and the description. Particularly preferred embodiments will be described in more detail on the basis of the accompanying drawings. The drawing shows:

FIG. 1 a schematic perspective view of an apparatus according to the invention comprising a mechanically switchable safety valve as a part of a safety device;

FIG. 2 a schematic view of parts of the apparatus according to FIG. 1 with the cover in a closed position;

FIG. 3 a frontal sectional view of parts of the apparatus according to FIG. 2;

FIG. 4 a schematic view of parts of the apparatus according to FIG. 1 with the cover in an access position; and

FIG. 5 a frontal sectional view of parts of the apparatus according to FIG. 4.

### DETAILED DESCRIPTION OF THE INVENTION

The apparatus shown in the drawings is configured and adapted for working and/or processing fish or parts thereof and comprises a multi-stage safety device according to the invention. The invention similarly also relates to apparatuses for working and/or processing other products from the food processing industry and the food and beverage industry, as well as all other industrial sectors in which operators are protected from reaching into tools that are ready to run. The invention further relates to apparatuses having just one safety level or having two safety levels.

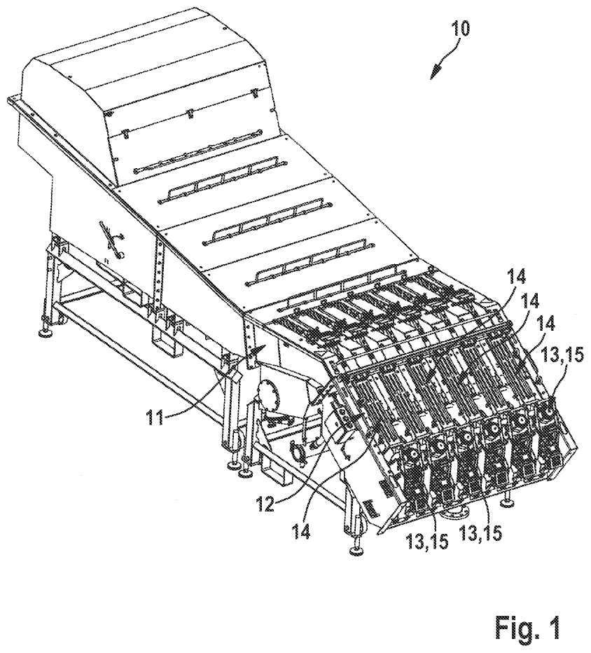

The drawing according to FIG. 1 shows an apparatus 10 that is configured and adapted for working and/or processing products. The apparatus 10 comprises a housing 11 having a work area 12 for accommodating at least one working station 13, at least one working station 13 within the work area 12, a movable cover 14 for opening and closing the housing 11 and covering the work area 12 with respect to the surroundings U, the or each working station 13 comprising at least one pneumatically actuatable tool 15, and the tool 15 and the movable cover 14 being operatively connected by means of a safety device 16 in such a way that the opening of the cover 14 inevitably leads to the tool 15 being stopped. Opening the cover 14 turns the or each tool 15 off.

According to the invention, this apparatus 10 is characterised in that the safety device 16 comprises a safety valve 17 that is configured to be switchable solely in a mechanical manner and, for that purpose, is operatively connected to the cover 14 at least in a form-fitting and/or frictional manner. The operative connection between the safety valve 17 and the cover 14 or parts thereof forms a first safety level in order to protect the operator against reaching into a tool 15 that is ready for operation. As soon as the cover 14 is opened, the compressed air of the or each tool 15 drops so as to render the tool inoperative, in a way that does not pose a hazard to the operator.

The features and developments described below represent preferred embodiments of the apparatus 10 when considered in isolation or in combination with one another. It is explicitly noted that features combined in the claims and/or the description and/or the drawings or described in a common embodiment can also refine the above-described apparatus 10 in a functionally independent manner.

The housing 11 can be a wholly closed structure having one or more working stations 13. The housing 11 can also have a frame structure, in which the or each working station 13 is safely secured against anyone reaching into a tool 15 that is ready for operation, preferably by a foldable or pivotable cover 14, flap, door or the like. A transport element, for example a transport chain or a conveyor belt, can be guided in or through the housing 11 and can be used for transporting the products into the operating range of the or each tool 15.

The operative connection between the safety valve 17 and the cover 14 can be established by a form fit and/or a frictional fit. Preferably, a combined form-fitting and frictional operative connection is provided. In other configurations, integrally bonded operative connections can of course also be implemented.

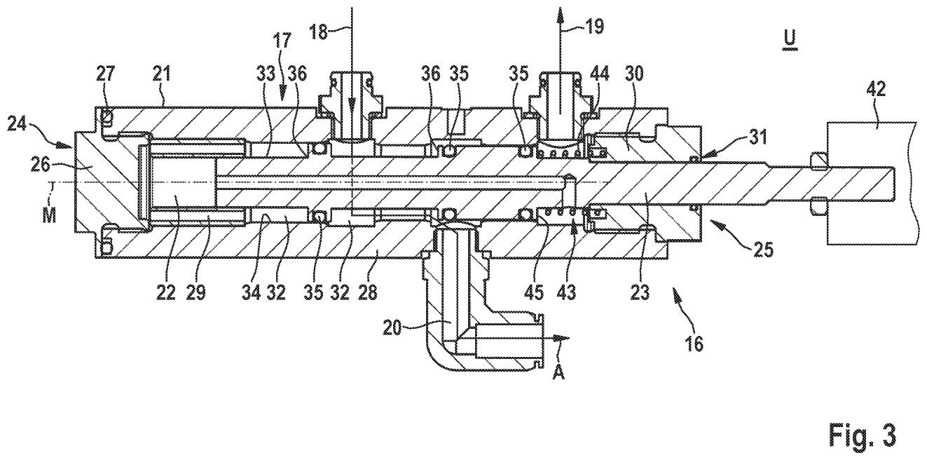

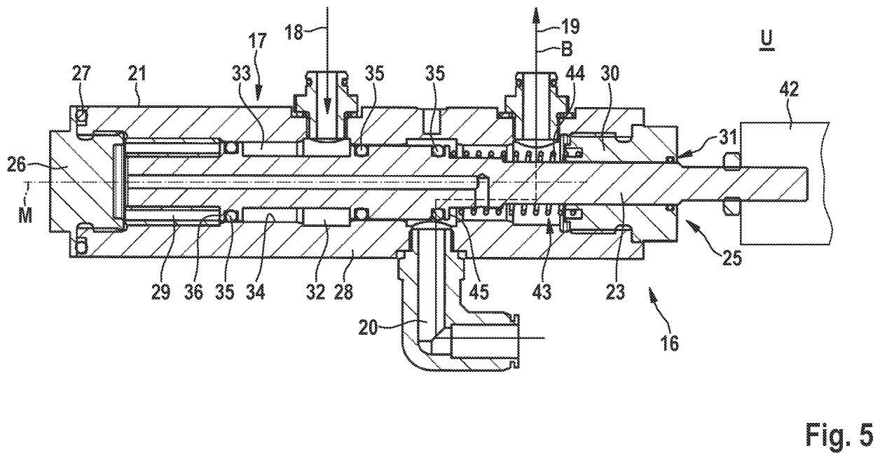

In the embodiment shown, the safety valve 17 is configured as a 3/2 valve. The safety valve 17 has three compressed-air openings, namely an air inlet 18 for feeding compressed air into the safety valve 17, an air outlet 19 for releasing compressed air from the safety valve 17 and a supply inlet 20 for supplying compressed air to the or each tool 15. The air inlet 18 is connected to a device for generating and/or conducting compressed air, which is then guided into the safety valve 17 via the air inlet 18. The air outlet 19 is used for carrying compressed air away and/or returning it from the safety valve 17. The supply inlet 20 leads from the safety valve 17 to the or each tool 15 of the working station 13 and can be coupled to the air inlet 18 or the air outlet 19 depending on the switching position of the safety valve 17, as a result of which two different flow connections/air paths (indicated by arrows A and B in FIGS. 3 and 5) can be generated. In the switching position in which the air inlet 18 is connected to the supply inlet 20 via air chambers for forming the flow connection, an air pressure that keeps the or each tool 15 ready for operation is applied to the supply inlet 20. In the switching position in which the supply inlet 20 is connected to the air outlet 19, the compressed air located at and in the tools 15 preferably escapes into the surroundings U so as to render the or each tool 15 inoperative.

The safety valve 17 comprises a hollow cylinder 21 having a cavity 22 in which a push rod 23 is guided in a sliding manner, the hollow cylinder 21 being configured in a closed manner at one end face 24 and in an open manner at the opposite end face 25 in such a way that the push rod 23 protrudes out of the hollow cylinder 21 at the open end face 25. The hollow cylinder 21 can be formed in one piece. Preferably, however, the hollow cylinder 21 comprises a plurality of parts. In the embodiment shown, the hollow cylinder 21 is connected to the closed end face 24 by a covering element 26 in a tight manner with respect to the compressed air. By way of example, the covering element 26 is sealed with respect to a wall 28 of the cylindrically shaped hollow cylinder 21 by means of a sealing ring 27 and is releasably connected to the wall 28. Inwardly, facing the cavity 22, the covering element 26 has a guide element 29, which can also be separately assigned to the covering element 26. The guide element 29 is configured and adapted for guiding a first free end of the push rod 23 inside the hollow cylinder 21. A guide element 30 is likewise arranged at the open end face 25 of the hollow cylinder 21 and is configured and adapted for guiding the opposite end of the push rod 23 inside the hollow cylinder 21 and has a through-opening 31, through which the push rod 23 protrudes out of the hollow cylinder 21.

The push rod 23 is inherently arranged with its outside circumference 33 at a distance from an inner wall 34 of the hollow cylinder 21 in order to form air chambers 32, the push rod 23 comprising at least three sealing members 35 by which the push rod 23 abuts the inner wall 33 of the hollow cylinder 21 in a sealing manner. The sealing members 35 are arranged in projections 36 on the push rod 23, which extend radially outwards. Thus, a plurality of air chamber portions of the air chamber 32 are formed between the outside circumference 33 of the push rod 23 and the inner wall 34 of the hollow cylinder 21 and can be selectively connected to one another by switching the push rod 23, i.e. by displacing the push rod 23 inside the hollow cylinder 21, in order to form the flow connections or air paths. The air inlet 18, the air outlet 19 and the supply inlet 20 open into the cavity 22 in the hollow cylinder 21, the establishment of flow connections between the air inlet 18 and/or air outlet 19 and/or supply inlet 20 being able to be varied by means of the movable push rod 23.

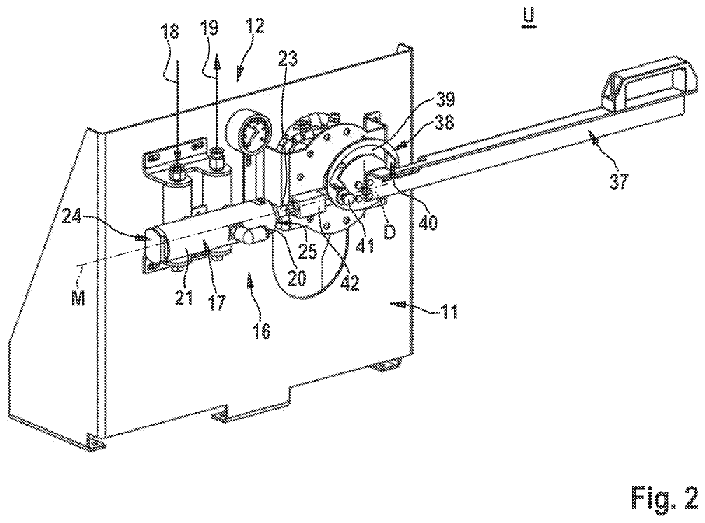

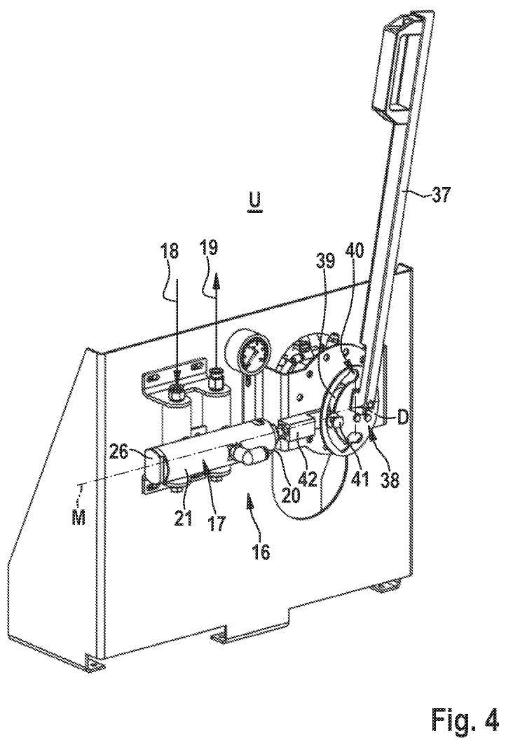

The operative connection between the safety valve 17 and the push rod 23 of the safety valve 17 on the one hand and the cover 14 on the other hand can be established directly. Preferably, the cover 14 is assigned an actuation lever 37, which comprises a cam disc 38 that is operatively connected to the push rod 23, which is assigned to the safety valve 17. The cover 14 and the cam disc 38 are preferably movable in synchronisation by means of the actuation lever 37. The rotation occurs about an axis of rotation D. Owing to the operative connection between the cam disc 38 and the push rod 23, said push rod is forced to perform a linear movement as a result of rotation of the cam disc 38. More precisely, the push rod 23 is configured and adapted to be movable, by means of the cam disc 38, out of a work position, in which the cover 14 is closed and the push rod 23 on the one hand ensures a flow connection between the air inlet 18 and the supply inlet 20 and on the other hand blocks the air outlet 19 (in this regard see in particular FIGS. 2 and 3), into a stop position, in which the cover 14 is opened and the push rod 23 on the one hand ensures a flow connection between the supply inlet 20 and the air outlet 19 and on the other hand blocks the air inlet 18 (in this regard see in particular FIGS. 4 and 5), and back again.

The shape and course of an adjustment cam 39 can vary. The adjustment cam 39 can be formed, inter alia, on the outside circumference of the cam disc 38. Preferably, the cam disc 38, as a closed cam disc 38, is configured and adapted for producing a constant form fit and/or frictional fit with the push rod 23 in order to switch the safety valve 17. The adjustment cam 39 is an arcuate curved path 40 in the cam disc 38, which is preferably mounted eccentrically with respect to the axis of rotation D. A connecting bolt 41 is arranged at a free end of the push rod 23, said free end protruding out of the hollow cylinder 21, and is guided in the closed curved path 40 of the cam disc 38. The connecting bolt 41 can be directly, and preferably releasably, fastened to the push rod 23 or to its end. Preferably, the end of the push rod 23 is arranged on a connecting member 42, to which the connecting bolt 41 is in turn preferably releasably fastened.

As is clear in particular from FIGS. 3 and 5, the air inlet 18 and the air outlet 19 are arranged one behind the other in the longitudinal direction of the hollow cylinder 21, along the central axis M thereof, the air outlet 19 being arranged closer to the open end face 25 of the hollow cylinder 21. Put another way, the air inlet 18 is located lower in the hollow cylinder 21 in the direction of the closed end face 24 of the hollow cylinder 21. Preferably, the air inlet 18 and the air outlet 19 extend in parallel with one another and open into the cavity 22 or into the corresponding portions of the air chamber 32 at a distance from one another. The air inlet 18 and the air outlet 19 are arranged at a distance from one another in the longitudinal direction of the hollow cylinder 21, the distance being large enough so that the supply inlet 20 is arranged and configured between the air inlet 18 and the air outlet 19. However, the individual compressed-air openings are spaced so far apart from one another as to prevent them from overlapping. In this case, the air inlet 18 and the air outlet 19 on the one hand and the supply inlet 20 on the other hand are arranged on opposite sides of the hollow cylinder 21 when viewed radially. It goes without saying that the positions of the air inlet 18, air outlet 19 and supply inlet 20 can vary along the central axis M and with respect to one another.

In the preferred embodiment, a spring element 43 is assigned to the safety valve 17, the spring element 43 being adapted and arranged such that, using a spring force, it pushes the push rod 23 inwards into the hollow cylinder 21 in the direction of the stop position. Preferably, a compression spring 44 is arranged in the region of the open end face 25 of the hollow cylinder 21 and abuts a projection 45 on the push rod 23 in such a way that a constant spring pressure is applied to the push rod 23 in the direction of the closed end face 24 of the hollow cylinder 21. The compression spring 44 is pressed, for example, against the hollow cylinder 21 or against a wall 28 thereof as a counter-bearing. In the embodiment shown, the compression spring 44 is assigned to the guide element 30 in the region of the open end wall 25 of the hollow cylinder 21. Banks of springs can also be provided instead of a single compression spring 44.

In the work position of the push rod 23, within an air chamber 32 in the flow connection between the air inlet 18 and the supply inlet 20 there is applied an air pressure that subjects the push rod 23 to a pressure force that is directed inwards into the hollow cylinder 21 in the direction of the stop position.

Starting from a closed cover 14 (see in particular FIGS. 2 and 3), the push rod 23 is in a position in which the flow connection between the air inlet 18 and the supply inlet 20 is activated. Thus, compressed air is applied in the portion of the air chamber 32 and thus to the or each tool 15, as a result of which the tools 15 are ready for operation. When the cover 14 is opened (see in particular FIGS. 4 and 5), the cam disc 38 is also moved and in turn switches the push rod 23, namely into a position in which the flow connection between the supply inlet 20 and the air outlet 19 is activated. Since the air inlet 18 is blocked, i.e. no further compressed air can be fed in, the compressed air escapes from that portion of the air chamber 32 that represents the flow connection between the supply inlet 20 and the air outlet 19. The compressed air escapes from the air chamber 32 and out of the or each tool 15 so that said tool is inoperative.

The operative connection between the safety valve 17 and the cover 14 ensures, as the first safety level, that the or each tool 15 is switched to be inoperative when the cover 14 is opened, as described above. If the first safety level were to fail, the second safety level in the form of the spring element 43 would take effect, which ensures that the push rod 23 is moved into the stop position in order to switch the or each tool 15 off in the event that there is no operative connection between the safety valve 17 and the cover 14. If this second safety level were to fail too, the third safety level would take effect in that the pressure level inside the air chamber 32 in the flow connection between the supply inlet 20 and the air inlet 18 ensures that the push rod 23 is moved into the stop position in order to switch the or each tool 15 off.

1-15. (canceled)

16. An apparatus configured and adapted for working and/or processing products, comprising:
a housing having a work area for accommodating at least one working station;
at least one working station within the work area;
a movable cover for opening and closing the housing and covering the work area with respect to surroundings;
the or each working station comprising;
at least one pneumatically actuatable tool;
the at least one pneumatically actuatable tool and the movable cover being operatively connected by a safety device in such a way that opening of the cover inevitably leads to the at least one pneumatically actuatable tool being stopped;
wherein the safety device comprises a safety valve that is configured to be switchable solely in a mechanical manner and, for that purpose, is operatively connected to the cover at least in a form-fitting and/or frictional manner.

17. The apparatus according to claim 16, wherein the safety valve is configured as a 3/2 valve, the safety valve comprising an air inlet for feeding compressed air into the safety valve, an air outlet for releasing compressed air from the safety valve, and a supply inlet for supplying compressed air to the at least one pneumatically actuatable tool.

18. The apparatus according to claim 17, wherein the safety valve comprises a hollow cylinder having a cavity in which a push rod is guided in a sliding manner, the hollow cylinder being configured in a closed manner at one closed end face and in an open manner at an opposite open end face in such a way that the push rod protrudes out of the hollow cylinder at the open end face.

19. The apparatus according to claim 18, wherein the push rod is inherently arranged with an outside circumference at a distance from an inner wall of the hollow cylinder in order to form air chambers, the push rod comprising at least three sealing members by which the push rod abuts the inner wall of the hollow cylinder in a sealing manner.

20. The apparatus according to claim 18, wherein the air inlet, the air outlet and the supply inlet open into the cavity in the hollow cylinder, the establishment of flow connections between the air inlet and/or air outlet and/or supply inlet being varied by the movable push rod.

21. The apparatus according to claim 18, wherein the cover is assigned an actuation lever, the actuation lever comprising a cam disc that is operatively connected to the push rod which is assigned to the safety valve.

22. The apparatus according to claim 21, wherein the push rod is configured and adapted to be movable, by the cam disc, out of a work position, in which the cover is closed and the push rod ensures a flow connection between the air inlet and the supply inlet and blocks the air outlet, into a stop position, in which the cover is opened and the push rod ensures a flow connection between the supply inlet and the air outlet and blocks the air inlet, and back again.

23. The apparatus according to claim 21, wherein the cam disc is a closed cam disc, and is configured and adapted for producing a constant form fit and/or frictional fit with the push rod in order to switch the safety valve.

24. The apparatus according to claim 21, wherein, at a free end of the push rod, said free end projecting out of the hollow cylinder, a connecting bolt is arranged, which is guided in a closed curved path of the cam disc.

25. The apparatus according to claim 18, wherein the air inlet and the air outlet are arranged one behind the other in a longitudinal direction of the hollow cylinder, the air outlet (19) being arranged closer to the open end face of the hollow cylinder.

26. The apparatus according to claim 17, wherein the air inlet and the air outlet are arranged at a distance from one another in a longitudinal direction of the hollow cylinder, the distance being large enough so that the supply inlet is arranged and configured between the air inlet and the air outlet.

27. The apparatus according to claim 17, wherein the air inlet and the air outlet on the one hand and the supply inlet on the other hand are arranged on opposite sides of the hollow cylinder when viewed radially.

28. The apparatus according to claim 22, wherein a spring element is assigned to the safety valve, the spring element being adapted and arranged such that, using a spring force, the spring element pushes the push rod inwards into the hollow cylinder in a direction of the stop position.

29. The apparatus according to claim 28, wherein the spring element comprises a compression spring arranged in a region of the open end face of the hollow cylinder and abutting a projection on the push rod in such a way that a constant spring pressure is applied to the push rod in a direction of the closed end face of the hollow cylinder.

30. The apparatus according to claim 22, wherein, in the work position within an air chamber in the flow connection between the air inlet and the supply inlet, an air pressure is applied that subjects the push rod to a pressure force that is directed inwards into the hollow cylinder in a direction of the stop position.
